(19) United States
(12) Patent Application Publication
(10) Pub. No.: US 2015/0261133 A1
(43) Pub. Date: Sep. 17, 2015

(54) DEVELOPING DEVICE AND IMAGE FORMING APPARATUS

(71) Applicant: FUJI XEROX CO., LTD., Tokyo (JP)

(72) Inventors: Norihiro TAMAZAWA, Kanagawa (JP); Shota OBA, Kanagawa (JP); Shigemi MURATA, Kanagawa (JP); Ryota TOMISHI, Kanagawa (JP)

(73) Assignee: FUJI XEROX CO., LTD., Tokyo (JP)

(21) Appl. No.: 14/592,532

(22) Filed: Jan. 8, 2015

(30) Foreign Application Priority Data
Mar. 17, 2014 (JP) 2014-053194

(51) Int. Cl. G03G 15/09

(52) U.S. Cl. CPC G03G 15/0889; G03G 15/09

(57) ABSTRACT

A developing device includes a developer container, a magnet member, a developer carrier including a rotary member, and a developer transport member, the magnet member including an attracting magnet pole that attracts a developer on the rotary member and a separation magnet pole that releases the developer. The attracting magnet pole is disposed upstream of a line segment connecting the centers of rotation of the rotary member and the transport member in a rotation direction of the rotary member. The magnetic force of the separation magnet pole is about 35 mT or more and about 45 mT or less, and the magnetic force of the attracting magnet pole is about 38 mT or more and about 54 mT or less. The angle formed by the magnet poles with respect to the center of rotation of the rotary member is about 98 degrees or more and about 117 degrees or less.

### CROSS-REFERENCE TO RELATED APPLICATIONS

This application is based on and claims priority under 35 USC 119 from Japanese Patent Application No. 2014-053194 filed Mar. 17, 2014.

### BACKGROUND

1. Technical Field

The present invention relates to a developing device and an image forming apparatus.

2. Summary

According to an aspect of the invention, there is provided a developing device including a developer container that contains a developer, a magnet member that is non-rotatably supported; a developer carrier that includes the magnet member, and a rotary member, which is disposed in such a manner as to surround an outer periphery of the magnet member and which rotates while holding the developer on a surface of the rotary member, and that develops a latent image, which is formed on a surface of an image carrier, and a transport member that is disposed in the developer container and that transports the developer in the developer container while stirring the developer, half or more of the transport member being disposed within a projected area of the developer carrier projected from above in a direction of gravity, wherein the magnet member includes at least an attracting magnet pole, which causes the developer to be attracted and held on the surface of the rotary member, and a separation magnet pole, which is disposed upstream of the attracting magnet pole in a direction of rotation of the rotary member and which separates the developer from the surface of the rotary member, the separation magnet pole being formed of a magnet pole having the same polarity as the attracting magnet pole. The attracting magnet pole is disposed further upstream than an imaginary line segment connecting the center of rotation of the rotary member and the center of rotation of the transport member in the direction of rotation of the rotary member. A magnetic force of the separation magnet pole is set to about 35 mT or more and about 45 mT or less, and a magnetic force of the attracting magnet pole is set to about 38 mT or more and about 54 mT or less. An angle formed by the separation magnet pole and the attracting magnet pole with respect to the center of rotation of the rotary member is set to about 98 degrees or more and about 117 degrees or less.

### BRIEF DESCRIPTION OF THE DRAWINGS

An exemplary embodiment of the present invention will be described in detail based on the following figures, wherein:

FIG. 1 is a diagram illustrating an image forming apparatus according to an exemplary embodiment;

FIG. 2 is a diagram illustrating a principal portion of the image forming apparatus according to the exemplary embodiment;

FIG. 3 is a diagram illustrating a developing device according to the exemplary embodiment;

FIG. 4 is a sectional view taken along line IV-IV of FIG. 3;

FIG. 5 is a diagram illustrating a magnetic member according to the exemplary embodiment and corresponding to FIG. 3;

FIG. 6 is a diagram illustrating a problem that occurs when the magnetic force of a pick-off magnetic pole is small;

FIG. 7 is a graph showing experimental results of Example 1 and having a horizontal axis that represents an angle between magnetic poles and a vertical axis that represents an evaluation value of an auger mark; and

FIG. 8 is a graph showing experimental results of Example 2 and having a horizontal axis that represents the magnetic force of a pick-up magnetic pole and a vertical axis that represents the magnetic force of the pick-off magnetic pole.

### DETAILED DESCRIPTION

An exemplary embodiment of the present invention will now be described as a specific example with reference to the drawings. However, the present invention is not limited to the following exemplary embodiment.

For ease of understanding of the following description, in the drawings, a front-rear direction, a left-right direction, and a top-bottom direction are respectively defined as the x-axis direction, the y-axis direction, and the z-axis direction, and directions or sides indicated by arrows X, -X, Y, -Y, Z, and -Z are respectively defined as a forward direction, a backward direction, a right direction, a left direction, an upward direction, and a downward direction or the front side, the rear side, the right side, the left side, the top side, and the bottom side.

In addition, a symbol having “•” in “◯” denotes an arrow extending from the distal side to the proximal side as viewed in the drawings, and a symbol having “×” in “◯” denotes an arrow extending from the proximal side to the distal side as viewed in the drawings.

Note that, in the following description, which refers to the drawings, descriptions of components that are not necessarily illustrated are omitted for ease of understanding of the following description.

### Exemplary Embodiment

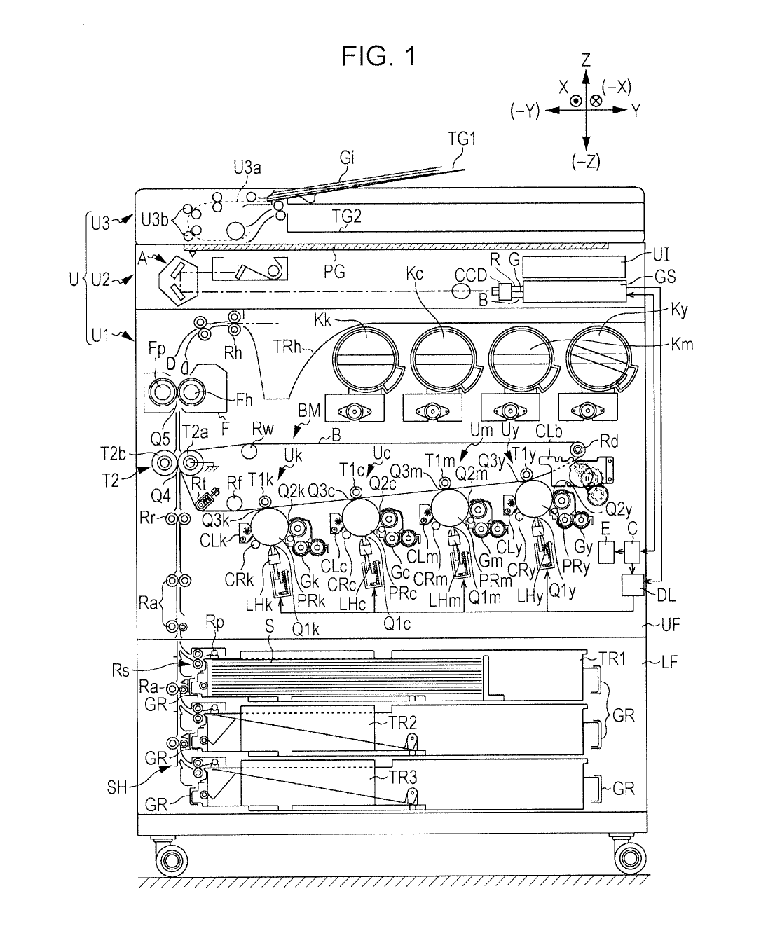

FIG. 1 is a diagram illustrating an image forming apparatus according to the exemplary embodiment.

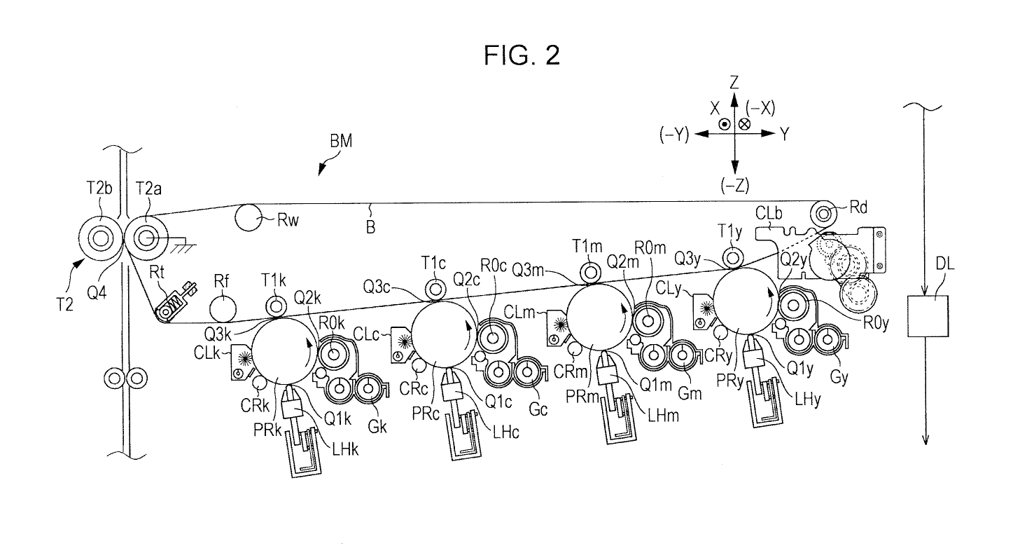

FIG. 2 is a diagram illustrating a principal portion of the image forming apparatus according to the exemplary embodiment.

In FIG. 1, a copying machine U, which is an example of the image forming apparatus of the exemplary embodiment of the present invention, includes a printer unit U1, which is an example of a recording unit and an example of an image recording device. A scanner unit U2, which is an example of a reading unit and an example of an image reading device, is supported on the printer unit U1. An autofeeder U3, which is an example of a document transport device, is supported on the scanner unit U2. A user interface UI, which is an example of an input unit, is supported in the scanner unit U2 of the exemplary embodiment. An operator may operate the copying machine U by performing an input operation by using the user interface UI.

A document tray TG1, which is an example of a medium container, is disposed on the autofeeder U3. Multiple documents Gi that are to be subjected to a copying operation may be stacked and accommodated in the document tray TG1. A document ejection tray TG2, which is an example of a document ejection unit, is formed below the document tray TG1. Document transport rollers U3b are disposed along a document transport path U3a between the document tray TG1 and the document ejection tray TG2.

A platen glass PG, which is an example of a transparent document table, is disposed on a top surface of the scanner unit U2. In the scanner unit U2 of the exemplary embodiment, a reading optical system A is disposed below the platen glass PG. The reading optical system A of the exemplary embodiment is supported in such a manner as to be movable in the left-right direction along a bottom surface of the platen glass PG. Note that the reading optical system A is normally stationary at an initial position illustrated in FIG. 1.

An imaging device CCD, which is an example of an imaging member, is disposed on the right side of the reading optical system A. An image processing unit GS is electrically connected to the imaging device CCD.

The image processing unit GS is electrically connected to a write circuit DL of the printer unit U1. The write circuit DL is electrically connected to light emitting diode (LED) heads LHy, LHm, LHc, and LHk, each of which is an example of a latent image forming device.

Photoconductor drums PRy, PRm, PRc, and PRk, each of which is an example of an image carrier, are disposed above the LED heads LHy to LHk, respectively.

Charging rollers CRy, CRm, CRc, and CRk, each of which is an example of a charger, are disposed in such a manner as to face the photoconductor drums PRy to PRk, respectively. A charged voltage is applied to the charging rollers CRy to CRk by a power supply circuit E. The power supply circuit E is controlled by a controller C, which is an example of a controller. The controller C also controls the image processing unit GS, the write circuit DL, and the like by performing signal transmission and reception with the image processing unit GS, the write circuit DL, and the like.

In write regions Q1y, Q1m, Q1c, and Q1k that are formed downstream of the charging rollers CRy to CRk in the direction of rotations of the photoconductor drums PRy to PRk, writing light beams are radiated onto surfaces of the photoconductor drums PRy to PRk from the LED heads LHy to LHk.

In development regions Q2y, Q2m, Q2c, and Q2k that are formed downstream of the write regions Q1y to Q1k in the rotation direction of the photoconductor drums PRy to PRk, developing devices Gy, Gm, Gc, and Gk are disposed in such a manner as to face the surfaces of the photoconductor drums PRy to PRk.

First transfer areas Q3y, Q3m, Q3c, and Q3k are formed downstream of the development regions Q2y to Q2k in the rotation direction of the photoconductor drums PRy to PRk. In the first transfer areas Q3y to Q3k, first transfer rollers T1y, T1m, T1c, and T1k, each of which is an example of a first transfer unit, are disposed in such a manner as to oppose the photoconductor drums PRy to PRk across an intermediate transfer belt B, which is an example of an intermediate transfer body. The first transfer rollers T1y to T1k are in contact with the intermediate transfer belt B in the first transfer areas Q3y to Q3k.

Drum cleaners CLy, CLm, CLc, and CLk, each of which is an example of an image carrier cleaning unit, are disposed downstream of the first transfer areas Q3y to Q3k in the rotation direction of the photoconductor drums PRy to PRk.

A belt module BM, which is an example of an intermediate transfer device, is disposed above the photoconductor drums PRy to PRk. The belt module BM includes the intermediate transfer belt B. The intermediate transfer belt B is rotatably supported by a driving roller Rd, which is an example of a driving member, a tension roller Rt, which is an example of a stretching member, a working roller Rw, which is an example of a serpentine correction member, an idle roller Rf, which is an example of a driven member, a backup roller T2a, which is an example of a member that faces a second transfer area Q4, and the first transfer rollers T1y, T1m, T1c, and T1k.

A second transfer roller T2b, which is an example of a second transfer member, is disposed so as to oppose the backup roller T2a across the intermediate transfer belt B. A second transfer unit T2 is formed of the backup roller T2a and the second transfer roller T2b. The second transfer area Q4 is formed of an area in which the second transfer roller T2b and the intermediate transfer belt B face each other.

The first transfer rollers T1y to T1k, the intermediate transfer belt B, the second transfer unit T2, and the like form a transfer device T1+T2+B of the exemplary embodiment that transfers images that have been formed on the photoconductor drums PRy to PRk onto a medium.

A belt cleaner CLb, which is an example of a cleaning unit for an intermediate transfer body, is disposed downstream of the second transfer area Q4 in the direction of rotation of the intermediate transfer belt B.

Cartridges Ky, Km, Kc, and Kk, each of which is an example of a developer container, are disposed above the belt module BM. Developers with each of which a corresponding one of the developing devices Gy to Gk is to be replenished are contained in the cartridges Ky to Kk. Each of the cartridges Ky to Kk and a corresponding one of the developing devices Gy to Gk are connected by a developer supply device (not illustrated).

Sheet feed trays TR1 to TR3, each of which is an example of a medium container, are disposed below the printer unit U1. The sheet feed trays TR1 to TR3 are supported by guide rails GR, each of which is an example of a guiding member, in such a manner as to be removable in the front-rear direction. Sheets S, each of which is an example of a medium, are accommodated in the sheet feed trays TR1 to TR3.

Pick-up rollers Rp, each of which is an example of a medium pick-up member, are disposed on the upper left sides of the sheet feed trays TR1 to TR3. Pairs of separation rollers Rs, each of which is an example of a separation member, are disposed on the left sides of the pick-up rollers Rp.

A transport path SH that extends upward and along which a medium is to be transported is formed on the left side of the sheet feed trays TR1 to TR3. Multiple transport rollers Ra, each of which is an example of a medium transport member, are disposed on the transport path SH. Registration rollers Rr, each of which is an example of a delivery member, are disposed on the transport path SH and positioned downstream in a direction in which the sheets S are to be transported and below the second transfer area Q4.

A fixing device F is disposed above the second transfer area Q4. The fixing device F includes a heating roller Fh, which is an example of a heating member, and a pressure roller Fp, which is an example of a pressure member. An area in which the heating roller Fh and the pressure roller Fp are in contact with each other forms a fixing area Q5.

Ejection rollers Rh, each of which is an example of a medium transport member, are disposed diagonally above the fixing device F. An ejection tray TRh, which is an example of a medium ejecting section, is formed on the right side of the ejection rollers Rh.

### (Description of Image Forming Operation)

The multiple documents Gi that are accommodated in the document tray TG1 sequentially pass through a document reading position on the platen glass PG and are ejected to the document ejection tray TG2.

In the case of performing a copying operation by automatically transporting the documents Gi by using the autofeeder U3, the reading optical system A exposes the documents Gi, which sequentially pass through the reading position on the platen glass PG, to light while being stationary at the initial position.

In the case where an operator performs a copying operation on the documents Gi by placing the documents Gi on the platen glass PG by their hands, the reading optical system A exposes to light and scans the documents Gi on the platen glass PG by moving in the left-right direction.

Light beams that have been reflected by the documents Gi are converged to the imaging device CCD through the optical system A. The imaging device CCD converts the light beams, which have been reflected by the documents Gi and have been converged to an imaging surface of the imaging device CCD, into electrical signals of red (R), green (G), and blue (B).

The image processing unit GS converts the electrical signals of R, G, and B that are input from the imaging device CCD into image information items of black (K), yellow (Y), magenta (M), and cyan (C), and the image information items are temporarily stored in the image processing unit GS. The image processing unit GS outputs the image information items, which are temporarily stored in the image processing unit GS, as image information items for use in latent image formation to the write circuit DL at a predetermined timing.

Note that, in the case where a document image is a monochromatic image, or specifically a black-and-white image, only a black (K) image information item is input to the write circuit DL.

The write circuit DL includes driving circuits for Y, M, C, and K colors (not illustrated) and outputs signals that correspond to image information items, which have been input to the write circuit DL, to the LED heads LHy to LHk, which are arranged so as to correspond to the colors, at a predetermined timing.

The surfaces of the photoconductor drums PRy to PRk are charged by the charging rollers CRy to CRk. Each of the LED heads LHy to LHk forms an electrostatic latent image on the surface of a corresponding one of the photoconductor drums PRy to PRk in a corresponding one of the write regions Q1y to Q1k. Each of the developing devices Gy to Gk develops the electrostatic latent image on the surface of a corresponding one of the photoconductor drums PRy to PRk into a toner image, which is an example of a visible image, in a corresponding one of the development regions Q2y to Q2k. When the developers are used by the corresponding developing devices Gy to Gk, the developing devices Gy to Gk are replenished with the corresponding developers from the corresponding cartridges Ky to Kk in accordance with the amounts of the developers, which have been used.

Each of the toner images on the surfaces of the photoconductor drums PRy to PRk is transported to a corresponding one of the first transfer areas Q3y, Q3m, Q3c, and Q3k. A first transfer voltage having a polarity opposite to the charge polarity of toners is applied to each of the first transfer rollers T1y to T1k by the power supply circuit E at a predetermined timing. Thus, in the first transfer areas Q3y to Q3k, the toner images on the photoconductor drums PRy to PRk are sequentially transferred onto the intermediate transfer belt B in such a manner as to be superposed with one another by the first transfer voltage. Note that, in the case of a black (K) monochromatic image, only a toner image of K color is transferred onto the intermediate transfer belt B from the photoconductor drum PRk for K color.

Each of the toner images on the photoconductor drums PRy to PRk is transferred in a first transfer process onto the intermediate transfer belt B, which is an example of an intermediate transfer body, by a corresponding one of the first transfer rollers T1y, T1m, T1c, and T1k. After the toner images have been transferred in the first transfer process, residues and attached substances on the surface of each of the photoconductor drums PRy to PRk are removed by a corresponding one of the drum cleaners CLy to CLk. The surfaces of the photoconductor drums PRy to PRk, which have been cleaned, are charged again by the corresponding charging rollers CRy to CRk.

One of the sheets S in one of the sheet feed trays TR1 to TR3 is taken out by a corresponding one of the pick-up rollers Rp at a predetermined sheet feed timing. In the case where the multiple sheets S have been taken out while being stacked on top of one another by one of the pick-up rollers Rp, the corresponding pair of separation rollers Rs separate the sheets S one by one. One of the sheets S that has passed through one of the pairs of separation rollers Rs is transported to a position where the registration rollers Rr are disposed by the multiple transport rollers Ra.

The registration rollers Rr send out the sheet S in accordance with the timing of transporting the toner images on a surface of the intermediate transfer belt B to the second transfer area Q4.

When the sheet S, which has been sent out by the registration rollers Rr, passes through the second transfer area Q4, the toner images on the surface of the intermediate transfer belt B are transferred onto the sheet S by a second transfer voltage that has been applied to the second transfer roller T2b.

The belt cleaner CLb cleans the surface of the intermediate transfer belt B, which has passed through the second transfer area Q4, by removing residual toner.

When the sheet S, which has passed through the second transfer area Q4, passes through the fixing area Q5, the fixing device F heats the toner images and applies pressure to the toner images in such a manner as to fix the toner images onto the sheet S.

The sheet S, to which the toner images have been fixed, is ejected to the ejection tray TRh by the ejection rollers Rh.

### (Description of Developing Device)

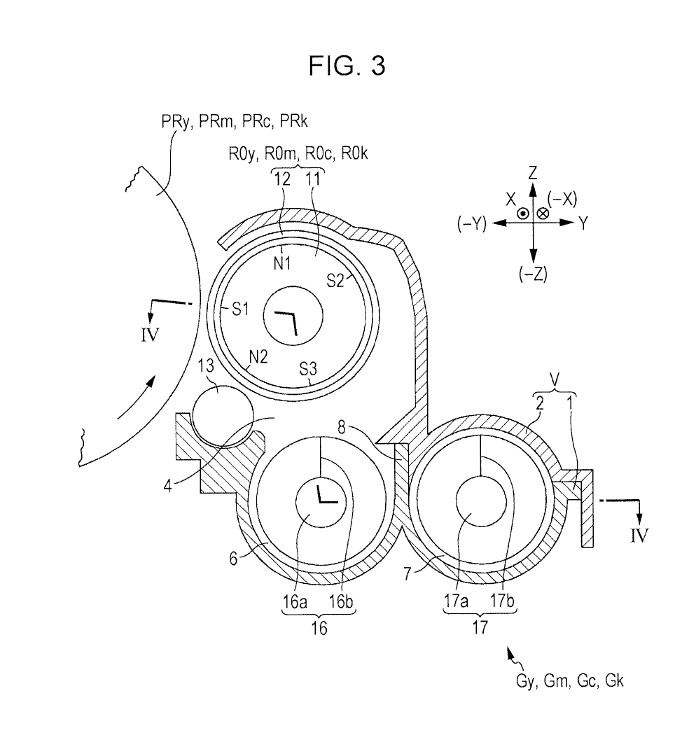

FIG. 3 is a diagram illustrating the developing device Gy of the exemplary embodiment.

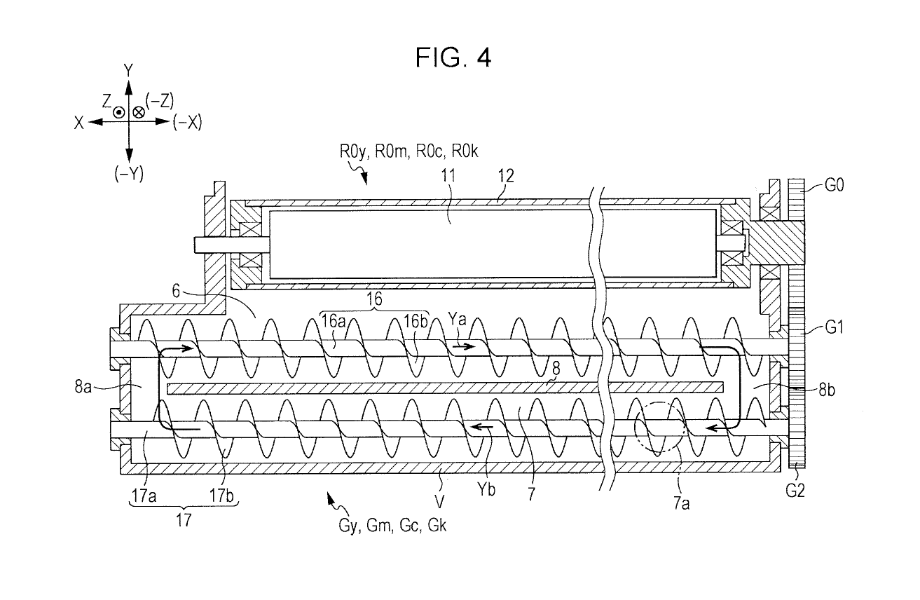

FIG. 4 is a sectional view taken along line IV-IV of FIG. 3.

Although the developing devices Gy, Gm, Gc, and Gk of the exemplary embodiment of the present invention will now be described, since the developing devices Gy, Gm, Gc, and Gk for the corresponding colors are configured in a similar manner, only the developing device Gy for Y color will be described in detail, and detailed descriptions of the developing devices Gm, Gc, and Gk for other colors are omitted.

In FIG. 3 and FIG. 4, the developing device Gy, which is disposed in such a manner as to face the photoconductor drum PRy, includes a developer container V that contains a two-component developer containing a toner and a carrier. In FIG. 3, the developer container V includes a developer container body 1, which is a lower portion of the developer container V. A container cover 2, which is an example of a cover member, is supported on the developer container body 1. The container cover 2 covers an upper surface of the developer container body 1.

In FIG. 3 and FIG. 4, a developing roller chamber 4, which is an example of an accommodating portion of a developer carrier, is formed on the upper left side in the developer container body 1. A supply chamber 6, which is an example of a first containing chamber, is formed below the developing roller chamber 4. The supply chamber 6 communicates with the developing roller chamber 4. A stirring chamber 7, which is an example of a second containing chamber, is formed on the right side of the supply chamber 6.

The supply chamber 6 and the stirring chamber 7 are separated from each other by a partition wall 8, which is an example of a partition member. In FIG. 4, a first inflow portion 8a that allows communication between the supply chamber 6 and the stirring chamber 7 and that is an example of a first communication portion is formed in front of the partition wall 8. Note that, in the exemplary embodiment, the first inflow portion 8a is positioned in front of a front end of the developing roller chamber 4. In addition, a second inflow portion 8b that allows communication between the supply chamber 6 and the stirring chamber 7 and that is an example of a second communication portion is formed behind the partition wall 8.

A developing roller R0y, which is an example of a developer carrier, is accommodated in the developing roller chamber 4. The developing roller R0y is disposed in such a manner that an upper left portion of an outer surface of the developing roller R0y faces the photoconductor drum PRy. The developing roller R0y includes a magnet roller 11, which is an example of a magnet member. In FIG. 4, the magnet roller 11 is non-rotatably supported on the developer container V. In FIG. 3 and FIG. 4, a developing sleeve 12, which is an example of a rotary member, is disposed over the outer periphery of the magnet roller 11. The developing sleeve 12 is rotatably supported on the developer container V. A gear G0, which is an example of a drive transmission member, is supported on a rear end of the developing sleeve 12. The gear G0 is configured to be capable of receiving a driving force that is transmitted from a motor (not illustrated), which is an example of a driving source. In the developing device Gy of the exemplary embodiment, when a driving force is transmitted to the gear G0 from the motor, the developing sleeve 12 rotates in the same direction as that in which the surface of the photoconductor drum PRy is moved in the development region Q2y.

A trimmer 13, which is an example of a member that controls the layer thickness of a developer, is disposed below the developing roller chamber 4. The trimmer 13 of the exemplary embodiment is in the form of a column that extends in the front-rear direction. The trimmer 13 is non-rotatably supported with a predetermined gap between the trimmer 13 and the developing sleeve 12.

In the magnet roller 11, a developing magnetic pole S1 is disposed in such a manner as to face the development region Q2y. A trimming magnetic pole N2, which is an example of a magnetic pole for controlling the layer thickness of a developer, is disposed at a position facing the trimmer 13. The trimming magnetic pole N2 is formed of a magnetic pole having a polarity opposite to that of the developing magnetic pole S1. In the direction of rotation of the developing sleeve 12, a transport magnetic pole N1 having a polarity opposite to that of the developing magnetic pole S1 is disposed downstream of the developing magnetic pole S1. In the rotation direction of the developing sleeve 12, a pick-off magnetic pole S2, which is an example of a magnetic pole for separating the developer, is disposed downstream of the transport magnetic pole N1. The pick-off magnetic pole S2 is formed of a magnetic pole having a polarity opposite to that of the transport magnetic pole N1. In the rotation direction of the developing sleeve 12, a pick-up magnetic pole S3, which is an example of a magnetic pole for attracting the developer, is disposed downstream of the pick-off magnetic pole S2 and upstream of the trimming magnetic pole N2. The pick-up magnetic pole S3 is formed of a magnetic pole having a polarity that is the same as that of the pick-off magnetic pole S2 and that is opposite to that of the trimming magnetic pole N2.

In FIG. 3 and FIG. 4, a supply auger 16, which is an example of a first transport member, is disposed in the supply chamber 6. The supply auger 16 includes a rotary shaft 16a that extends in the front-rear direction. A helical transport blade 16b is supported on the outer periphery of the rotary shaft 16a. A gear G1, which is an example of a drive transmission member, is supported on a rear end of the rotary shaft 16a.

A stirring auger 17, which is an example of a second transport member, is disposed in the stirring chamber 7. Similarly to the supply auger 16, the stirring auger 17 includes a rotary shaft 17a, a transport blade 17b, and a gear G2. The gears G0 to G2 are engaged with one another.

In FIG. 4, a supply port 7a via which the developer is to be supplied to the stirring chamber 7 from the cartridge Ky is formed in a rear portion of the stirring chamber 7.

### (Function of Developing Device)

In each of the developing devices Gy to Gk having the above-described configuration, when image formation starts, the augers 16 and 17 and the developing rollers R0y to R0k are driven by the motor so as to rotate. In the exemplary embodiment, when the supply auger 16 rotates, the supply auger 16 transports the developer in the supply chamber 6 in a direction from the first inflow portion 8a toward the second inflow portion 8b, which is indicated by arrow Ya, while stirring the developer. The developer that has been transported to the second inflow portion 8b enters the stirring chamber 7 through the second inflow portion 8b. When the stirring auger 17 rotates, the stirring auger 17 transports the developer in the stirring chamber 7 in a direction from the second inflow portion 8b toward the first inflow portion 8a, which is indicated by arrow Yb, while stirring the developer. The developer that has been transported to the first inflow portion 8a enters the supply chamber 6 through the first inflow portion 8a. Accordingly, the supply chamber 6 and the stirring chamber 7 form a circulation chamber 6+7.

The developer in the supply chamber 6 is attracted and held on the developing sleeve 12 by the magnetic force of the pick-up magnetic pole S3. When the developer that has been held on the developing sleeve 12 passes above the trimmer 13, only a predetermined amount of the developer that corresponds to the gap between the trimmer 13 and the developing sleeve 12 passes above the trimmer 13. In the development regions Q2y to Q2k, the developers, each of which has passed above the corresponding trimmer 13, develop latent images on the corresponding photoconductor drums PRy to PRk. Each of the developers that have not been used in development operations is transported, while being held on a surface of the corresponding developing sleeve 12, by a magnetic field between the corresponding developing magnetic pole S1 and the corresponding transport magnetic pole N1, a magnetic field between the transport magnetic pole N1 and the corresponding pick-off magnetic pole S2, and the like. In areas between the pick-off magnetic poles S2 and the corresponding pick-up magnetic poles S3, which have the same polarity, the magnetic forces that cause the developers to be attracted and held on the corresponding developing sleeves 12 are small. Thus, the developers, which have been held on the surfaces of the developing sleeves 12, separate from the developing sleeves 12 in the areas between the pick-off magnetic pole S2 and the corresponding pick-up magnetic pole S3 and return to the corresponding circulation chambers 6+7.

### (Description of Each Portion of Developing Device)

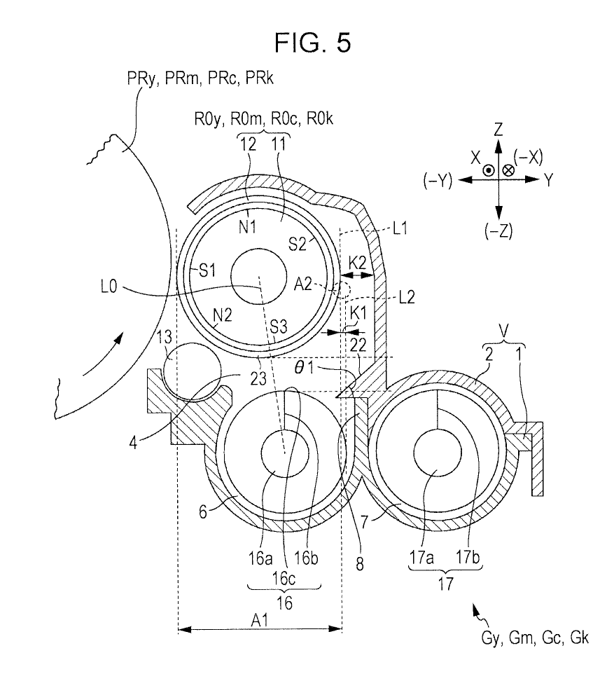

FIG. 5 is a diagram illustrating a positional relationship between the members that are included in the developing device Gy of the exemplary embodiment and corresponding to FIG. 3.

In FIG. 5, in the developing device Gy of the exemplary embodiment, the rotary shaft 16a of the supply auger 16 is disposed within a projected area A1 of the developing roller R0y projected from above in the direction of gravity. In other words, in the developing device Gy of the exemplary embodiment, half or more of the supply auger 16 is disposed within the projected area A1 of the developing roller R0y.

Thus, in the developing device Gy of the exemplary embodiment, the developing roller R0y and the supply auger 16 are approximately superposed with each other in the horizontal direction. As a result, the developing device Gy of the exemplary embodiment is smaller than that of the related art.

As illustrated in FIG. 5, assume that a tangent line that is in contact with the outer surface of the developing roller R0y on the side opposite to the side on which the photoconductor drum PRy is disposed and that extends in the direction of gravity is a first imaginary tangent line L1. In addition, assume that a tangent line that is in contact with an outer edge of the transport blade 16b of the supply auger 16 on the side opposite to the side on which the photoconductor drum PRy is disposed and that extends in the direction of gravity is a second imaginary tangent line L2. In the developing device Gy of the exemplary embodiment, the second imaginary tangent line L2 is positioned farther from the photoconductor drum PRy than the first imaginary tangent line L1 is in the horizontal direction.

As illustrated in FIG. 5, the distance between the first imaginary tangent line L1 and the second imaginary tangent line L2 in the horizontal direction is a first distance K1. In addition, the distance between the developing roller R0y and an inner surface of the developer container V in the horizontal direction on the side opposite to the side on which the photoconductor drum PRy is disposed is a second distance K2. In the developing device Gy of the exemplary embodiment, the first distance K1 is set to be smaller than the second distance K2.

In FIG. 5, in the developing device Gy of the exemplary embodiment, the pick-up magnetic pole S3 is disposed further upstream than an imaginary line segment L0 connecting the center of rotation of the developing sleeve 12 and the center of rotation of the supply auger 16 in the rotation direction of the developing sleeve 12.

The magnetic force of the pick-up magnetic pole S3 of the exemplary embodiment is set within a range of 38 mT or about 38 mT to 54 mT or about 54 mT and is preferably set within a range of 43 mT or about 43 mT to 53 mT or about 53 mT.

When the magnetic force of the pick-up magnetic pole S3 is below 38 mT, it is difficult to attract the developer. In particular, when the magnetic force of the pick-up magnetic pole S3 is 43 mT or about 43 mT or larger, the developer is likely to be reliably attracted. The total amount of the developer, which is contained in the developing device Gy, decreases as the size of the developing device Gy is reduced. If the total amount of the developer is small, in the case where the total amount of the developer reaches a lower limit when the total amount varies at the timing of using the developer or at the timing of supplying the developer, it is difficult to attract the developer. Therefore, the magnetic force of the pick-up magnetic pole S3 may be 43 mT or about 43 mT or larger from the standpoint of securing the pick-up performance of the pick-up magnetic pole S3.

On the other hand, when the magnetic force of the pick-up magnetic pole S3 is larger than 54 mT, the amount of the developer that is to be attracted becomes too large, and a load and a stress to be applied to the developer become excessive. In addition, there is a problem in that a torque that drives the developing sleeve 12 increases. It is particularly preferable that the magnetic force of the pick-up magnetic pole S3 be 53 mT or about 53 mT or smaller due to the upper limit of the driving torque.

The magnetic force of the pick-off magnetic pole S2 of the exemplary embodiment is set within a range of 35 mT or about 35 mT to 45 mT or about 45 mT.

The magnetic force of the pick-off magnetic pole S2 is limited by the balance between the magnetic force of the pick-off magnetic pole S2 and the magnetic force of the pick-up magnetic pole S3. When the magnetic force of the pick-off magnetic pole S2 is larger than 45 mT, a release position 01 between the pick-up magnetic pole S3 and the pick-off magnetic pole S2 where the developer falls off due to a small magnetic force is too close to the pick-up magnetic pole S3 due to the relationship between the magnetic force of the pick-off magnetic pole S2 and the magnetic force of the pick-up magnetic pole S3. In the case where the release position 01 where the developer falls off is too close to the pick-up magnetic pole S3, the developer that has just fallen off is likely to be attracted by the pick-up magnetic pole S3, which is positioned close to the developer, before being stirred by the supply auger 16. In particular, the developer, which falls off upon the rotation of the developing sleeve 12, receives a force toward a direction in which a line tangent to the developing sleeve 12 extends, and in the case where the release position 01 is close to the pick-up magnetic pole S3, the direction in which the line tangent to the developing sleeve 12 extends is a direction toward the pick-up magnetic pole S3. Thus, the developer that has fallen off is likely to be attracted by the pick-up magnetic pole S3 without reaching the supply auger 16. As a result, there is a possibility that the developer that has not been sufficiently stirred may be supplied to the development region Q2y.

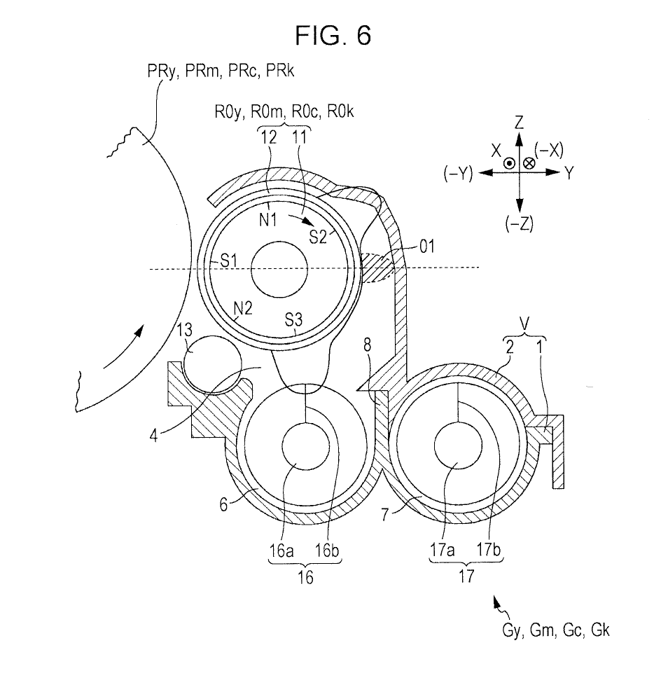

FIG. 6 is a diagram illustrating a problem that occurs when the magnetic force of the pick-off magnetic pole S2 is small.

When the magnetic force of the pick-off magnetic pole S2 is below 35 mT, the magnetic force of the pick-off magnetic pole S2 becomes too small due to the relationship with the magnetic force of the pick-up magnetic pole S3. In FIG. 6, as the magnetic force of the pick-off magnetic pole S2 decreases, the release position 01 between the pick-up magnetic pole S3 and the pick-off magnetic pole S2 where the developer falls off due to a small magnetic force comes near the pick-off magnetic pole S2. In this case, a magnetic brush, which is formed as a result of the developer being napped by the transport magnetic pole N1, falls down toward the pick-off magnetic pole S2 (toward downstream in the rotation direction of the developing sleeve 12), and when the magnetic brush has been transported to the release position 01, the magnetic brush falls down toward the pick-off magnetic pole S2 (toward upstream in the rotation direction of the developing sleeve 12). Such movements (tumbling) of the magnetic brush are actively performed, so that toner cloud occurs.

In addition, there is a problem in that, when the developer is accumulated as described above, a gap between the developing roller R0y and the inner surface of the developer container V is filled with the developer. When the developing sleeve 12 rotates, air is taken into the developer container V from the development region Q2y. In this case, when the gap has been filled with the developer, it is difficult for the air to flow, and the pressure in the developer container V increases. There is a problem in that, when the pressure has increased to such an extent as to push out the developer with which the gap has been filled, a phenomenon in which air bursts out in such a manner as to cause a developer to float in a cloud-like form occurs, such a phenomenon being so-called toner cloud. In the case where the toner cloud occurs, there is a problem in that the interior of the copying machine U gets contaminated, and the developer is attached to the surface of the photoconductor drum PRy, resulting in a decrease in image quality.

In the related art, there is a configuration in which a container cover is formed to have a double structure in such a manner that a path that allows air to flow is formed in order to suppress a jet of air. However, in the case of employing such a double structure, there are problems in that it is difficult to realize a size reduction and that the manufacturing costs increase.

In the exemplary embodiment, the angle formed by the pick-up magnetic pole S3 and the pick-off magnetic pole S2 with respect to the center of rotation of the developing sleeve 12 is set within a range of 98 degrees or about 98 degrees to 117 degrees or about 117 degrees and is preferably set within a range of 104 degrees or about 104 degrees to 114 degrees or about 114 degrees.

There is a limitation on manufacturing the magnet roller 11 in that, when the angle formed by the magnetic poles S2 and S3 with respect to the center of rotation of the developing sleeve 12 is 118 degrees or larger, the pick-off magnetic pole S2 and the pick-up magnetic pole S3 are too close to the transport magnetic pole N1 and the trimming magnetic pole N2, respectively, and as a result, it is difficult to manufacture the magnet roller 11. In contrast, when the angle formed by the magnetic poles S2 and S3 is smaller than 98 degrees or about 98 degrees, an image defect is likely to occur in experimental results.

In the exemplary embodiment, when the position of the developing magnetic pole S1 is at an angle of 0 degrees as an example, the trimming magnetic pole N2 is positioned at an angle of 86 degrees with respect to a direction opposite to the rotation direction of the developing sleeve 12. Similarly, the pick-up magnetic pole S3 is positioned at an angle of 140 degrees, the pick-off magnetic pole S2 is positioned at an angle of 250 degrees, and the transport magnetic pole N1 is positioned at an angle of 315 degrees.

In the exemplary embodiment, as an example, the magnetic force of the developing magnetic pole S1 is set to 115 mT, and the magnetic force of the trimming magnetic pole N2 is set to 55 mT. The magnetic force of the transport magnetic pole N1 is set to 98 mT. The magnetic force of the pick-up magnetic pole S3 is set to 48 mT or about 48 mT, and the magnetic force of the pick-off magnetic pole S2 is set to 43 mT or about 43 mT. Note that, in the exemplary embodiment, on the basis of knowledge of the inventors of the present invention that the likelihood of an image defect due to a pick-off failure may be reduced in the case where the magnetic force of the pick-off magnetic pole S2 is set to be smaller than that of the pick-up magnetic pole S3 by 5 to 10 mT, the knowledge being based on past experiments and the like, tentative center values are set, and after that, values within a tolerance range are adopted.

In the developing device Gy of the exemplary embodiment, which has the above-described configuration, the pick-up magnetic pole S3 is disposed further upstream than the imaginary line segment L0 in the rotation direction of the developing sleeve 12. In the case where the pick-up magnetic pole S3 is disposed upstream of the imaginary line segment L0, the release position 01 where the developer falls off is at a high position, and detachability of the developer is likely to deteriorate. Accordingly, in the related art, such a pick-up magnetic pole is generally disposed downstream of such an imaginary line segment. However, the size reduction of the developing device Gy described in the exemplary embodiment limits the position of the supply auger 16 and a position at which the trimmer 13 may be disposed. Along with this, the position of the trimming magnetic pole N2 is limited, and the position of the pick-up magnetic pole S3 with respect to the trimming magnetic pole N2 is limited as well. Accordingly, the pick-up magnetic pole S3 is disposed upstream of the imaginary line segment L0 in the exemplary embodiment.

In the exemplary embodiment, the magnetic force of the pick-up magnetic pole S3 is set within a range of 38 mT or about 38 mT to 54 mT or about 54 mT. In a developing device of the related art, a pick-up magnetic pole having a magnetic force of 60 mT or larger has been typically used. In contrast, in the exemplary embodiment, the magnetic force of the pick-up magnetic pole S3 is reduced.

In addition, in the exemplary embodiment, the magnetic force of the pick-off magnetic pole S2 is set within a range of 35 mT or about 35 mT to 45 mT or about 45 mT.

In addition, in the exemplary embodiment, the angle formed by the pick-up magnetic pole S3 and the pick-off magnetic pole S2 with respect to the center of rotation of the developing sleeve 12 is set within a range of 98 degrees or about 98 degrees to 117 degrees or about 117 degrees.

Next, experiments are performed in order to confirm the effects of the exemplary embodiment.

### Example 1

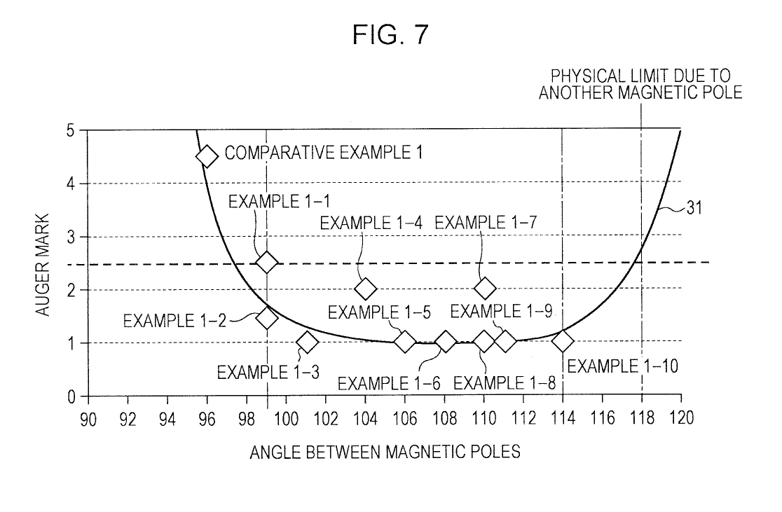

In Example 1, multiple magnet rollers 11 are formed. In the multiple magnet rollers 11, the pick-up magnetic poles S3 and the corresponding pick-off magnetic poles S2 form different angles in the range of 96 degrees to 114 degrees with respect to the center of rotation of the corresponding developing sleeves 12, and image formation is performed by employing the configuration of the exemplary embodiment. In Example 1, observations for detection of image defects in a striped pattern called auger marks each of which corresponds to the transport blade 16b of the supply auger 16 in images that have been formed are conducted. Results of the observations are evaluated by the sensory evaluation. When there is no auger mark, a grade is zero (G0), and the grade (G) increases as an auger mark become noticeable. In the Example 1, G2.5 or lower is an acceptable range, and G2.0 or lower is a preferable range. Experimental results are shown in FIG. 7.

FIG. 7 is a graph showing the experimental results of Example 1 and having a horizontal axis that represents the angle between the magnetic poles and a vertical axis that represents an evaluation value of an auger mark.

As shown in FIG. 7, the experimental results are approximated and represented by an approximate curve 31. It is understood that printing may be performed with image quality within the acceptable range when the angle is within the range of 97 degrees where the approximate curve 31 intersects G2.5 to 117 degrees where the approximate curve 31 intersects G2.5, and it is understood that the preferable range is 98 degrees where the approximate curve 31 intersects G2.0 to 116 degrees where the approximate curve 31 intersects G2.0. In particular, it is understood that the range of 104 degrees to 114 degrees in which the approximate curve 31 is stable in a substantially linear form is a further preferable range.

### Example 2

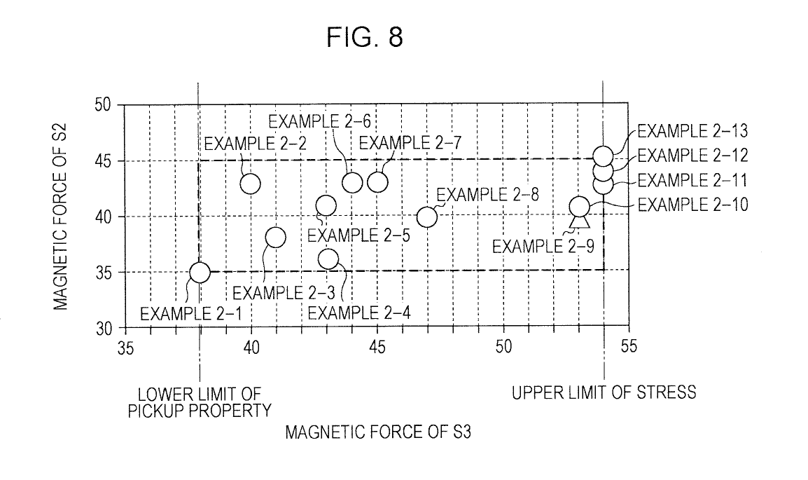

In Example 2, multiple magnet rollers 11 each of which includes the pickup magnetic pole S3 and the pickoff magnetic pole S2 are formed. The magnetic forces of the pickup magnetic pole S3 are different from one another, and the magnetic forces of the pickoff magnetic pole S2 are different from one another. In Example 2, the sensory evaluation of auger marks is performed in a similar manner to Example 1. Experimental results are shown in a graph illustrated in FIG. 8, and in the graph, a symbol of “◯” denotes G2.0 or lower, and a symbol of “Δ” denotes G2.5.

FIG. 8 is a graph showing the experimental results of Example 2 and having a horizontal axis that represents the magnetic force of the pick-up magnetic pole S3 and a vertical axis that represents the magnetic force of the pick-off magnetic pole S2.

As shown in FIG. 8, it is understood from the experimental results that the grade is G2.5 or lower when the magnetic force of the pickup magnetic pole S3 is in the range of 38 mT to 54 mT, and the magnetic force of the pickoff magnetic pole S2 is in the range of 35 mT to 45 mT.

### (Modifications)

Although the exemplary embodiment of the present invention has been described in detail above, the present invention is not limited to the above-described exemplary embodiment, and various changes may be made within the scope of the present invention as described in the claims. Exemplary modifications (H01 to H03) of the present invention will be described below.

(H01) Although the copying machine U has been described in the above-described exemplary embodiment as an example of an image forming apparatus, the image forming apparatus is not limited to this and may be formed of, for example, a printer, a facsimile machine, a multifunction machine that has some or all of the functions of the printer and the facsimile machine, or the like.

(H02) Although in the above-described exemplary embodiment, the configuration of the copying machine U in which developers of the four colors are to be used has been described as an example, the present invention may also be applied to, for example, a monochromatic image forming apparatus or a multicolored image forming apparatus that uses developers of 5 or more colors or three or less colors.

(H03) The number of magnetic poles of the magnet roller 11 is not limited to five, which has been described as an example in the above-described exemplary embodiment. For example, a magnet roller that includes an odd number, such as three, seven or more, of magnetic poles may be used.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a developer container that contains a developer;
a magnet member that is non-rotatably supported;
a developer carrier that includes the magnet member, and a rotary member, which is disposed in such a manner as to surround an outer periphery of the magnet member and which rotates while holding the developer on a surface of the rotary member, and that develops a latent image, which is formed on a surface of an image carrier; and
a transport member that is disposed in the developer container and that transports the developer in the developer container while stirring the developer, half or more of the transport member being disposed within a projected area of the developer carrier projected from above in a direction of gravity,
wherein the magnet member includes at least an attracting magnet pole, which causes the developer to be attracted and held on the surface of the rotary member, and a separation magnet pole, which is disposed upstream of the attracting magnet pole in a direction of rotation of the rotary member and which separates the developer from the surface of the rotary member, the separation magnet pole being formed of a magnet pole having the same polarity as the attracting magnet pole,
wherein the attracting magnet pole is disposed further upstream than an imaginary line segment connecting the center of rotation of the rotary member and the center of rotation of the transport member in the direction of rotation of the rotary member,
wherein a magnetic force of the separation magnet pole is set to about 35 mT or more and about 45 mT or less,
wherein a magnetic force of the attracting magnet pole is set to about 38 mT or more and about 54 mT or less, and
wherein an angle formed by the separation magnet pole and the attracting magnet pole with respect to the center of rotation of the rotary member is set to about 98 degrees or more and about 117 degrees or less.

2. The developing device according to claim 1,
wherein the magnetic force of the attracting magnet pole is set to about 43 mT or more and about 53 mT or less, and
wherein the angle formed by the separation magnet pole and the attracting magnet pole with respect to the center of rotation of the rotary member is set to about 104 degrees or more and about 114 degrees or less.

3. An image forming apparatus comprising:
an image carrier;
a latent image forming device that forms a latent image on a surface of the image carrier;
the developing device according to claim 1 that develops the latent image on the surface of the image carrier into a visible image;
a transfer device that transfers the visible image on the surface of the image carrier onto a medium; and
a fixing device that fixes the visible image on a surface of the medium onto the medium.

4. An image forming apparatus comprising:
an image carrier;
a latent image forming device that forms a latent image on a surface of the image carrier;
the developing device according to claim 2 that develops the latent image on the surface of the image carrier into a visible image;
a transfer device that transfers the visible image on the surface of the image carrier onto a medium; and
a fixing device that fixes the visible image on a surface of the medium onto the medium.
